(19) United States
(12) Patent Application Publication
(10) Pub. No.: US 2026/0237894 A1
(43) Pub. Date: Aug. 13, 2026

(54) Semi-Transparent Radome for In-Flight Connectivity Terminal

(71) Applicant: RAVE Aerospace, LLC, Brea, CA (US)

(72) Inventor: Matteo Berioli, Munich (DE)

(73) Assignee: RAVE Aerospace, LLC, Brea, CA (US)

(21) Appl. No.: 19/167,123

(22) PCT Filed: Jun. 15, 2023
(86) PCT No.: PCT/US2023/025396

§ 371 Date: Sep. 19, 2025

(51) Int. Cl. H01Q 1/42; H01Q 1/02; H01Q 1/28; H01Q 3/34

(52) U.S. Cl. CPC H01Q 1/42; H01Q 1/02; H01Q 1/282; H01Q 3/34

(57) ABSTRACT

Enclosures for aircraft antenna are described which utilizes a semi-transparent radome having both a transparent portion and a non-transparent portion. The transparent portion permits the transmission and receipt of electromagnetic waves, while the non-transparent portion can be used to dissipate heat from the enclosure that is generated by the antenna. The enclosure has a skirt that connects with the radome to create a smooth profile without any air inlets, ducts, or fins. Heat transfer mechanisms such as a heat pipe, or systems to increase the natural air convection, can be used to move heat from the antenna to the walls of the enclosure to thereby dissipate heat to the outside air.

### FIELD OF THE INVENTION

The field of the invention is satellite enclosures for aircraft.

### BACKGROUND

The following description includes information that may be useful in understanding the present invention. It is not an admission that any of the information provided herein is prior art or relevant to the presently claimed invention, or that any publication specifically or implicitly referenced is prior art.

Some antennas used for in-flight communications have high power consumption in the order of several hundreds of Watts (e.g., 1,000 W), such as phased array, electronically steered antennas. The ARINC792 standard foresees consumption up to 2,000 W. When an antenna with high power consumption (e.g. a phased array, electronically steered antenna) is used for in-flight communications, heat dissipation becomes a challenging issue. Most of this power translates into heat, generated under the radome. Typically, heat remains inside the radome because radomes are often made of materials that do not have good heat transfer properties, such as fiberglass.

Thus, the heat generated by the antenna needs to be properly dissipated and moved out of the radome. Otherwise, the temperature of the system under the radome can rise uncontrollably. To prevent this, the antenna will typically have a shutdown protection mechanism to shut down the antenna if the temperature rises past a defined threshold (e.g., 80° C.).

For these reasons, use of antennas with high power consumption is very limited for in-flight communications.

Various solutions have been attempted to address the heat dissipation. They often rely on air inlets or ducts to steer outside airflow inside the radome and push the airflow to some heat exchange compartments. Other solutions utilize openings and move air across the openings with fans. The use of ducts or inlets poses challenges in the aerodynamics of the profile, in particular with such structures, and it is often difficult to guarantee a laminar air flow above and around the radome and to avoid vortices. The openings may also allow dust, dirt, and foreign objects to enter the radome, leading to increased maintenance for the antenna.

Another attempted solution is to utilize heat fins in direct contact with external air, and eliminate the inlets and heat exchange compartment. While this can ameliorate the issue of dust and the additional requirement for maintenance, it poses aerodynamic challenges and increase the risk of creating acoustic noises and whistles.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved enclosures for antennas that offer heat transfer mechanisms without the need for air inlets, ducts or other openings on the enclosure.

### SUMMARY OF THE INVENTION

The inventive subject matter provides apparatus, systems, and methods for antenna enclosures that are configured to be mounted to a fuselage of an aircraft. In some embodiments, the antenna comprises an electronically steered antenna mounted to the adapter plate and having two or more flat phased-array panels.

The enclosures provide a structure that houses the antenna or a set of antennas, providing physical support, protection, and shielding from weather and other external factors that could interfere with the antenna's operation. Contemplated enclosures comprise a radome that defines an upper portion of the enclosure and a skirt defining a lower portion of the enclosure. The skirt is disposed between the fuselage of the aircraft and the radome when the enclosure is mounted to the aircraft. Collectively, the skirt and radome preferably enclosure one or more antennas disposed within the enclosure.

Preferably, the radome comprises both a non-transparent portion and a transparent portion, and wherein the transparent portion is composed of a radio-transmissive material. As used herein, the term “transparent” means radio-transmissive (i.e., permits radio waves or signals to pass through), and the term “non-transparent” means non-radio-transmissive (i.e., does not allow for the transmission of radio waves or signals through or does but with significant attenuation or distortion). As used herein, the term “radio-transmissive material” means materials that allow for the transmission and receipt of radio waves or radio signals through them without significant attenuation or distortion. Examples of radio-transmissive materials are certain types of glass such as quartz and borosilicate glass, and various types of plastics and polycarbonate.

The non-transparent portion of the radome and the skirt are preferably composed of the same or different non-radio-transmissive material(s). In contrast to radio-transmissive materials, the non-radio-transmissive materials are materials that do not allow for the transmission of radio waves or signals through them or do but with significant attenuation or distortion. Examples of non-radio-transmissive materials metals, concrete, and brick.

It is especially preferred that the non-transparent portion of the radome and the skirt are composed of one or more high thermal conductive materials. As used herein, the term “high thermal conductive materials” means substances or materials that have the ability to conduct or transfer heat effectively, and preferably materials that have a thermal conductivity of at least 100 W/m*K at room temperature. Examples of high thermal conductive materials include metals such as copper, aluminum, and silver.

The enclosure further comprises one or more heat transfer mechanisms disposed below the antenna and configured to move heat away from the antenna to outside of the enclosure. In preferred embodiments, the heat transfer mechanism comprises a heat pipe that moves heat away from the antenna where the heat is generated to the skirt and/or non-transparent portion of the radome, which have a high thermal conductivity.

The use of heat pipes advantageously allows the materials of the enclosure to expel heat from the enclosure without the need for an air inlet or duct to cool the interior of the enclosure. The enclosure including the radome and skirt can be formed without inlets or ducts such that it has a smooth profile that is non-porous, and therefore impermeable to liquids, dirt, or gases. This prevents foreign materials from entering the enclosure, protecting the antenna and reducing required maintenance.

Rather, the heat pipe utilizes its closed-loop system and phase changes of a working fluid therein to continuously move heat from one part of the heat pipe to another. By placing the heat pipe below the antenna, heat generated from the antenna can be moved toward the enclosure, which due to its thermal conductivity, provides an effective heat exchange with the ambient outside air, which is often at a temperature substantially lower than the temperature of the antenna when powered on.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an isometric view of one embodiment of an enclosure having a semi-transparent radome.

FIG. 2 illustrates a front view of the enclosure of FIG. 1.

FIG. 3 illustrates a side view of the enclosure of FIG. 1.

FIG. 4 illustrates the enclosure of FIG. 1 without the radome.

FIG. 5 illustrates one embodiment of a heat transfer mechanism as used with the enclosure of FIG. 1.

FIG. 6 illustrates a depiction of an aircraft having an antenna on a top surface of the fuselage.

FIG. 7 illustrates a depiction of an aircraft having an antenna on a bottom surface of the fuselage.

FIG. 8 illustrates an abstract thermal model of the enclosure to study the heat exchange between the different parts of the enclosure.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

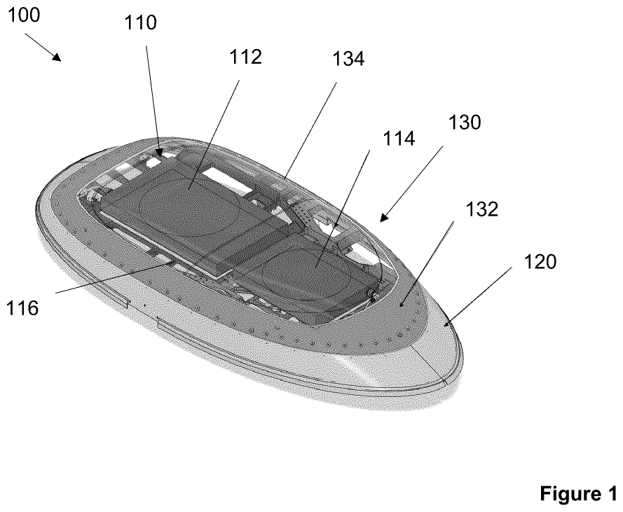

FIGS. 1-5 illustrates one embodiment of an enclosure 100 for an antenna 110 configured to be mounted to an aircraft. The enclosure 100 preferably comprises a skirt or fairing 120 that defining a lower portion of the enclosure 100 between a fuselage of the aircraft and a radome 130. As shown, the radome 130 defines an upper portion of the enclosure 100.

It is especially preferred that the radome 130 comprises both a non-transparent portion 132 and a transparent portion 134. As shown in the Figures, it is contemplated that the non-transparent portion 132 of the radome 130 is disposed between the transparent portion 134 of the radome 130 and the skirt or fairing 120.

The transparent portion 134 preferably is composed of one or more radio-transmissive materials, while the non-transparent portion 132 and the skirt 120 are each composed of one or more non-radio-transmissive materials. It is especially preferred that one or both of the non-transparent portion 132 and the skirt 120 are composed of high thermal conductive material, such that the non-transparent portion 132 and/or the skirt 120 can be used to facilitate heat transfer between an interior of the enclosure 100 and the ambient environment.

It is preferred that the transparent portion is composed of low thermal conductive material, such as fiberglass or those materials described above, for example.

The materials used for the transparent portion of the radome needs to be transparent to Radio Frequencies (RF), i.e. in in-flight connectivity Ku or Ka bands frequencies are used, and for these materials, such as fiberglass, the Thermal Conductivity is typically very low (<0.1 W/(mK) for fiberglass).

In preferred embodiments, the high thermal conductive material is aluminum which has a high thermal conductivity of approximately 237 W/m*K at room temperature and is lightweight. However, any commercially suitable material(s) could be used that have a high thermal conductivity without departing from the scope of the invention. The choice of material will depend on the specific requirements of the system and the desired level of thermal conductivity needed.

As can be seen in the Figures, the enclosure 100 which comprises the skirt 120 and the radome 130 has a smooth profile. In other words, the skirt 120 and the radome 130 preferably have a consistent, uninterrupted, and uniform surface without any apertures or ducts. The surface can therefore be described as nonporous and the enclosure 100 can therefore keep out foreign objects including debris, fluids, or gases.

In some embodiments, and as shown in FIG. 1, the antenna 110 comprises an electronically steered antenna mounted to an adapter plate 116 and disposed underneath the radome 130. The antenna 110 is shown having two flat, phased-array panels 112, 114. Such antennas have high power consumption and can create a significant amount of heat, which must be dissipated to avoid damage to the electronics or the antenna shutting down.

As discussed above, prior art solutions dissipated heat by introducing changes to the radome profile that improved heat transfer by utilizing outside air such as through air inlets, openings in the radome, or fins. In contrast, the inventive subject matter discussed herein does not require a change in the shape or profile of the enclosure 100 including the radome 130, with respect to classical radome profiles used for low-power antennas. Instead, the material of the radome 130 is changed, in the portions of the radome 130 in which RF transmissions do not pass. The material of the skirt or fairing 120 is also changed as needed to a material with a high thermal conductivity.

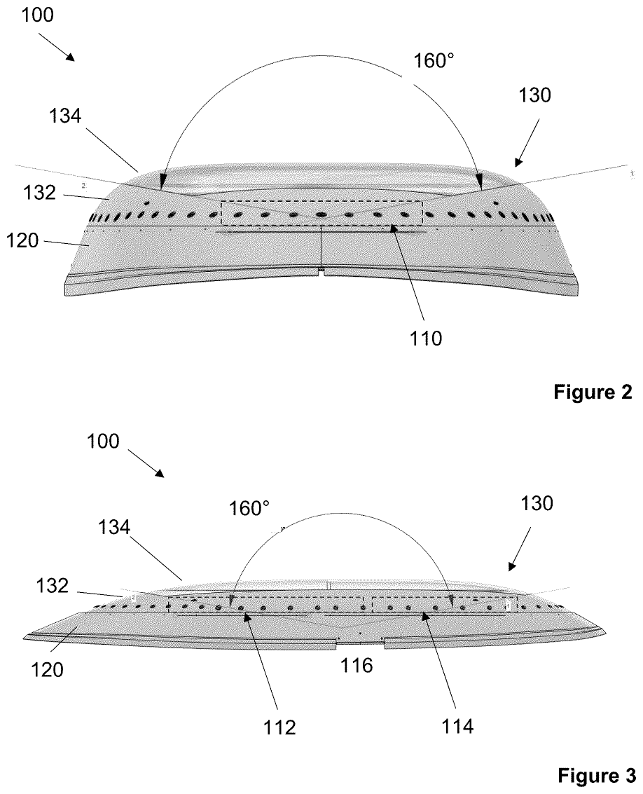

FIG. 2 illustrates a front view of the enclosure 100. As discussed above, the radome 130 is divided into two portions: a non-transparent portion 132 and a transparent portion 134. The divide or cut (between RF-transparent and non-RF-transparent material) that defines the two portions can be defined in different ways, e.g., such as by using a simple planar cut, or in a more qualitative way, such as by following the profile of the edges of the antennas 110 or of the radome 130.

As discussed above, the entire radome surface does not need to be crossed by the electromagnetic (EM) waves. By understand the specifications and dimensions of the antennas inside the radome, the type of network the antenna is communicating with (e.g., Geostationary or Low-Earth Orbit satellites), the inventors discovered that is possible to clearly identify and define the radome areas that need to be crossed by the EM waves. The focus of the present invention is to therefore to create a radome in which the use of the RF-transparent and low-thermal-conductivity material (e.g., fiberglass) is strictly limited to the areas that need to be crossed by the EM waves.

An example is given in FIG. 1. An electronically steered antenna for satellite communications, is composed of two flat phased-array panels, one for Transmission (TX) and one for Reception (RX). They are installed on an adapter plate and a radome is covering the adapter plate, and a fairing (or skirt) is closing the gap between the edge of the adapter plate and the airplane fuselage.

Typically, the entire radome and the fairing are made of low-thermal-conductivity material. As described in the inventive concepts described herein, a portion of the radome areas that need to be crossed by the EM waves can be identified, and the material of that portion of the radome can be changed to allow higher heat transfer in the areas that do not need to be crossed by the EM waves.

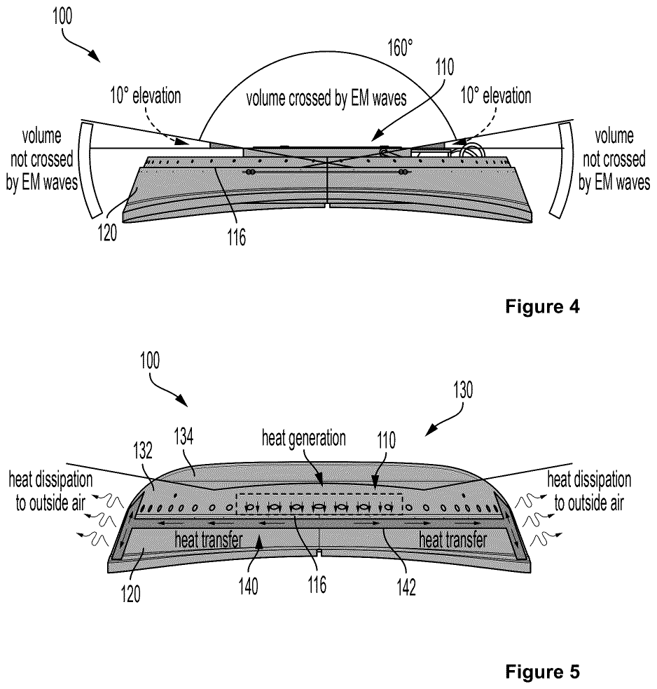

Flat antennas can usually point only along look angles between 90° elevation (broadside), down to 20° or 10° of elevation. Assuming a worse case of 10°, the volumes around the antennas, which can be crossed by EM waves, are easily identified (see FIG. 4). Extending these cut planes to the radome, it is possible to identify a cut line along the entire radome profile that signs the border between the areas that are crossed by EM waves and areas that cannot be crossed by EM waves (s. FIG. 2 and FIG. 3). Now, it is possible to use a material with good thermal conductivity properties (e.g., aluminum) for the parts that do not need to be RF-transparent, while the parts that are crossed by the EM waves shall remain made of RF-transparent material (see FIG. 1).

Assuming that the antenna 110 can only point to look at angles between 10° and 90° elevation, FIG. 4 illustrate the volumes that can be crossed by electromagnetic waves. As one example shown in FIG. 4, the angle of the cut between the RF-transparent and the non-RF-transparent part of the radome is shown to be at 10° elevation with respect to the edges of the upper surface of the antenna 110. In such embodiment, the non-transparent portion 134 therefore covers from 0 degree to +10 degree elevation with respect to the edges of the upper surface of the antenna 110.

FIG. 3 illustrate a side view of the enclosure 100 shown in FIG. 1. Again, the angle of the cut or divide between the non-transparent portion 132 and the transparent portion 134 is shown to be at 10° elevation with respect to the edges of the upper surface of the panels 112, 114 of the antenna 110.

FIG. 2 illustrates a front view of the enclosure 100 showing the adapter plate 116 with the antenna 110 mounted on top of the adapter plate 116.

FIG. 5 illustrates another front view of the enclosure 100 showing the radome 130 covering the adapter plate 116 and the antenna 110. The skirt 120 extends about the adapter plate 116 and connect to the radome 130.

A heat transfer mechanism 140 is disposed below the antenna 110 and configured to transfer or move heat from the antenna 110 to outside of the enclosure 100. In preferred embodiments, the heat transfer mechanism 140 comprises one or more heat pipes 142. As shown in the Figure, the heat pipe 142 moves heat that is generated by the antenna 110 toward the sides of the enclosure 100 (as shown by the arrows). The heat is then dissipated outside of the enclosure 100 via heat exchange between the hot ambient created inside the enclosure 100 and the outside air using the skirt 120 and/or non-transparent portion 132 of the radome 130.

The use of high thermal conductive material(s) for the skirt 120 and the non-transparent portion 132 of the radome 130 allows the enclosure 100 to maintain a regular smooth profile without the need for irregular structures, such as air inlets, ducts, or fins. In addition, the enclosure can avoid a radome profile that could otherwise have aerodynamics and vortex issues or acoustic noise issues due to air inlets, ducts, or fins. In addition, the impermeable surfaces of the radome 130 and skirt 120 prevent the entry of dust, dirt, and foreign objects, which reduces the overall maintenance required.

It is further contemplated that the area where the adapter plate 116 and an antenna dissipation heat plate of the antenna 110 contact one another can be maximized to increase heat transfer. Further, the contact conductivity between the adapter plate 116 and the antenna dissipation heat plate can be improved by removing on the contact area the epoxy primer, adding thermal grease, and/or adding a surrounding sealant to prevent corrosion.

It is also contemplated that the hard contact area between the adapter plate 116 and the skirt 120 can be maximized, such as by adding two lines of rivets instead one and reducing the separation between them. Aluminum fasteners could also be used to improve the conductivity between the adapter plate 116 and the skirt 120. An exemplary aluminum fastener is an aluminum solid countersunk rivet model NAS1097AD4 with a 3.2 mm diameter.

It is also contemplated that in some embodiments, a fan or other means could be used to circulate air within the enclosure 100. In these embodiments, the air convection inside the enclosure can also be used to increase the heat transfer from the antenna 110 to outside of the enclosure 100. The natural convection is present in any case, but mechanisms could be put in place to increase the convection coefficient. Such mechanisms could include for example fans, that move air inside the enclosure 100. Another mechanism can be to introduce on the enclosure 100 small venting openings 116 (in FIG. 3). Such openings, differently from inlets or ducts, do not let a lot of air flow inside the enclosure, but they can create a small turbulence around the opening area, enough to move air inside the enclosure. These heat transfer effects created by the convection can be used in addition to the heat pipes or in place of the heat pipe effect.

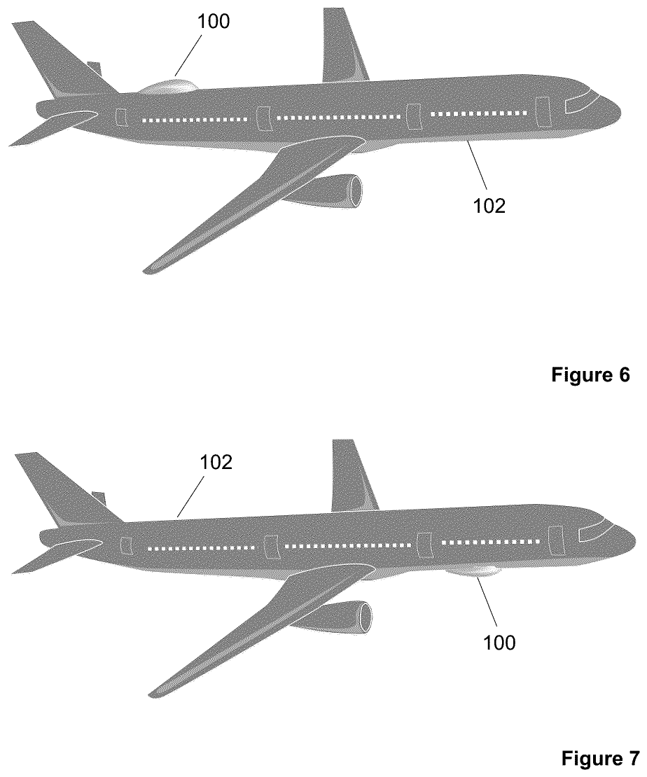

FIG. 6 and FIG. 7 illustrate examples of the enclosure 100 being mounted to a fuselage of an aircraft 102. In FIG. 6, the enclosure 100 is mounted to a top surface of the fuselage, while in FIG. 7 the enclosure 100 is mounted to a bottom surface of the fuselage.

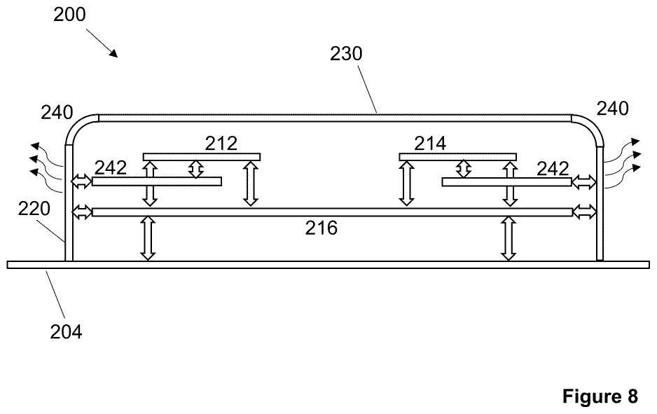

FIG. 8 illustrates a thermal model of the enclosure to study the heat exchange between the different parts of the enclosure. An enclosure 200 is mounted to a fuselage 204 of an aircraft. The enclosure 200 preferably comprises a skirt or fairing 220 that defines a lower portion of the enclosure 200 and a radome 230 defining an upper portion of the enclosure 200. An electronically steered antenna is disposed within the enclosure 200 and underneath the radome 230, and comprises two flat, phased-array panels 212, 214 mounted to an adapter plate 216.

It is preferred that the radome comprises a non-transparent portion 240 and a transparent portion 230, such as described above. The transparent portion preferably is composed of radio-transmissive materials that typically have a low thermal conductivity. An exemplary material is fiberglass having a thermal conductivity of <0.1 W/m*K.

The non-transparent portions of the radome 240 and the skirt 220 are preferably composed of one or more high thermal conductive materials, such that the non-transparent portions 240 and/or the skirt 220 can be used to facilitate heat transfer between an interior of the enclosure 200 and the outside air. In some embodiments, the high thermal conductive material is aluminum. However, any commercially suitable material(s) could be used that have a high thermal conductivity without departing from the scope of the invention. The choice of material will depend on the specific requirements of the system and the desired level of thermal conductivity needed.

Heat pipes 242 can be used to move heat from the panels 212, 214 of the antenna to the skirt 220 and/or non-transparent portion of the radome 240.

The various arrows illustrate how heat can be moved within the enclosure 200 to the side walls and dissipated through heat transfer using the skirt 220 and/or non-transparent portion of the radome 240.

The enclosure 200 preferably have a consistent, uninterrupted, and uniform surface without any apertures or ducts.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. An enclosure for an antenna configured to be mounted to an aircraft, comprising:
a skirt defining a lower portion of the enclosure between a fuselage of the aircraft and a radome;
wherein the radome defines an upper portion of the enclosure;
wherein the radome comprises both a non-transparent portion and a transparent portion, and wherein the transparent portion is composed of a radio-transmissive material. and wherein the skirt is composed of a high thermal conductive material;
a heat transfer mechanism disposed below the antenna and configured to move heat from the antenna outside of the enclosure; and
wherein an outside surface of the skirt and radome comprise a smooth profile that is non-porous.

2. The enclosure of claim 1, wherein the non-transparent portion of the radome is disposed between the transparent portion of the radome and the skirt.

3. The enclosure of claim 1, wherein the non-transparent portion and the skirt are composed of one or more non-radio-transmissive materials.

4. The enclosure of claim 3, wherein the non-transparent portion is composed of a high thermal conductive material and wherein the transparent portion is composed of a low thermal conductive material.

5. The enclosure of claim 4, wherein the non-transparent portion and skirt are composed of aluminum.

6. The enclosure of claim 1, wherein the non-transparent portion covers 0 to 10 degrees elevation with respect to edges of the upper surface of the antenna.

7. The enclosure of claim 1, wherein the heat transfer mechanism comprises a heat pipe.

8. The enclosure of claim 1, wherein the heat pipe comprises a closed-loop system having a working fluid that moves heat from one portion of the heat pipe to another portion.

9. The enclosure of claim 1, wherein the heat pipe moves heat from the antenna to the skirt or non-transparent portion of the radome, and wherein the skirt or non-transparent portion of the radome act as a heat exchanger with an outside air to move the heat outside of the antenna.

10. (canceled)

11. An aircraft antenna comprising:
an adapter plate;
an electronically steered antenna mounted to the adapter plate and comprising two flat phased-array panels;
a radome covering the adapter plate and at least partially enclosing the antenna; and
a skirt extending around the adapter plate and connected to the radome, wherein the skirt is composed of a high thermal conductive material;
wherein the radome comprises a non-transparent portion disposed adjacent to the skirt and a transparent portion composed of a radio-transmissive material;
a heat transfer mechanism disposed below the antenna and configured to move heat from the antenna outside of the enclosure; and
wherein an outside surface of the skirt and radome comprise a smooth profile that is non-porous.

12. The aircraft antenna of claim 11, wherein the non-transparent portion of the radome is disposed between the transparent portion of the radome and the skirt.

13. The aircraft antenna of claim 11, wherein the non-transparent portion and the skirt are composed of one or more non-radio-transmissive materials.

14. The aircraft antenna of claim 13, wherein the non-transparent portion is composed of a high thermal conductive material and wherein the transparent portion is composed of a low thermal conductive material.

15. The aircraft antenna of claim 14, wherein the non-transparent portion and skirt are composed of aluminum.

16. The aircraft antenna of claim 11, wherein the non-transparent portion covers 0 to 10 degrees elevation with respect to edges of the upper surface of the antenna.

17. The aircraft antenna of claim 11,
wherein the heat transfer mechanism comprises one or more heat pipes.

18. The aircraft antenna of claim 17, wherein the one or more heat pipes comprise a closed-loop system having a working fluid that moves heat from one portion of one or more heat pipes to another portion.

19. The aircraft antenna of claim 18, wherein the one or more heat pipes moves heat from the antenna to the skirt or non-transparent portion of the radome, and wherein the skirt or non-transparent portion of the radome act as a heat exchanger with an outside air to move the heat outside of the antenna.

20. (canceled)
